(19) United States
(12) Patent Application Publication
(10) Pub. No.: US 2003/0116966 A1
(43) Pub. Date: Jun. 26, 2003

(54) Bullthread

(76) Inventor: Franklin E. Gray, Glendora, CA (US)

Correspondence Address: MERCHANT & GOULD PC, P.O. BOX 2903, MINNEAPOLIS, MN, 55402-0903, US

(21) Appl. No.: 10/269,747

(22) Filed: Oct. 4, 2002

Related U.S. Application Data
(60) Provisional application No. 60/327,392, filed on Oct. 4, 2001.

(51) Int. Cl. F16L 25/00

(52) U.S. Cl. 285/334.1; 285/393

(57) ABSTRACT

A connector for use in combination with piping to transform plumbing pipe stub outs to re-sealable leak-proof open or closed stub outs. The connector is an elongated hollow cylindrical brass fitting having first and second ends wherein the first end slides into an open end of a copper stub out pipe and securely attached thereto. The second end of the elongated hollow cylindrical brass fitting has a threaded interior surface that is configured as a female threaded receptor to engage a male threaded plug. The threaded plug removably engages the second end of the elongated hollow cylindrical brass fitting by screwing into or out of the elongated hollow cylindrical brass fitting. The insertion and removal of the threaded plug allows for the drain of debris, pressure testing and inspection of the copper piping throughout a newly constructed building without the traditional cutting and recapping now permanently closed stub outs which may have been bullet stub outs or stub outs that have been soldered closed.

This application claims priority from provisional application Serial No. 60/327,392, filed Oct. 4, 2001, and which is incorporated herein by reference.

### FIELD OF THE INVENTION

The present invention relates an apparatus to be used in the plumbing field or any water, waste water or air applications where fixture stub outs are used during rough and new construction.

### BACKGROUND OF THE INVENTION

New building construction plumbing used specifically for water applications has been traditionally implemented by extending copper or other rigid tubing behind and parallel to walls, floors and ceilings of the building and then out of a hole in the interior surface wall and terminating as a stub out. A popular stub out configuration currently being used in new building construction by plumbers is a spun closed “bullet” stub out.

During building construction, following installation of the interior surface wall around the protruding plumbing pipe stub out, pressure tests are run on the plumbing pipe assembly. One of the problems resulting from the use of the spun closed “bullet” stub out in new construction plumbing is that the inspector, home owner and builder has no way of testing the pipe assembly to determine whether the plumber has done an accurate job with the connection and extension of the plumbing pipe throughout the building. This is because of the closed copper tip on the “bullet” that extends away from the building wall and then out of a hole in the interior surface wall. Another problem resulting from completion of the building and plumbing assembly is that the pipes may have debris that has accumulated therein. A builder or plumber needs to have the ability to blow out any such accumulated debris. Debris cannot be blown out of the pipe assembly nor can it be tested without opening the closed copper tip on the “bullet” stub out. The only known method for opening a “bullet” stub out is to cut the tip off. After the “bullet” stub out tip is opened, it has to be closed again. Closing of the tip is performed by welding a cap onto the end of the extending pipe. There is a need for a stub out assembly that is sealed and can then be resealed without the steps of cutting copper pipe and re-welding a cap onto the end of the stub out.

One structure that provides a stub out that is sealed and can be opened and resealed is a male iron pipe (“MIP”) adapter or female iron pipe (“FIP”) adapter with a PVC cap on the end. The problem with using an MIP or FIP adapter in a plumbing environment as a stub out to which it is desired to attach a toilet or any other apparatus that needs to be connected to the building water supply, is that the MIP or FIP adapter size does not allow for the use of plumbing shelf products such as an escutcheon ring. There is a need for a stub out that is sealed and can be opened and resealed without the steps of cutting copper pipe and re-welding a cap onto the end of the stub out while maintaining the integrity of the copper pipe assembly so that existing plumbing shelf products may be used.

### BRIEF DESCRIPTION OF THE DRAWINGS

FIG. 1 is a perspective view of the connector portion of invention attached to a copper pipe;

FIG. 2 is an enlarged, cross-sectional view of the connector portion of invention connected to a copper pipe, taken along line 2-2 of FIG. 1;

FIG. 3 is an exploded perspective view of the invention; and

FIG. 4 is a top view of the connector portion of invention.

### SUMMARY OF THE INVENTION

It is an object of the present invention to provide a one piece re-sealable pre-assembled plumbing stub out, wherein the end of the stub out to which plumbing fixtures would be attached has a threaded section at a first end that allows a removable seal to threadingly engage the stub out to create a leak proof seal. The threaded section in one embodiment is within the interior walls of the first end of the stub out. In another embodiment, the threaded section is on the exterior walls of the first end of the stub out. The threaded end of the stub out may remain open or be closed by a threaded male plug that is screwed into the threaded end of the stub configured as a female member for the threaded connection. Alternatively, when the threaded end of the stub out has a threaded section on the exterior walls of a section of the first end of the stub out, it may be capped by a female cap that is screwed over the threaded end of the stub out which acts as a male threaded connector. It is the object of the invention to provide a leak proof stub out for use with piping in plumbing constructions. The stub out has a removable plug or cap that provides a leak proof seal on the stub out when engaged and provides an open end to the stub out when the plug is removed. The plug or cap may be removed and securely engaged without the need to solder or cut the stub out pipe. It is a further object of the present invention to remove the step of cutting copper or rigid piping when it is desirable to attach an angle stop. It is a further object of the present invention to provide a cap or plug for the stub out that is reusable and void of mess and expense associated with soldering and removal of soldered plug and caps on pipe stub outs.

The invention is an elongated hollow cylindrical rigid stub out pipe fitting having first and second ends. The second end of the elongated hollow cylindrical rigid fitting has a threaded section on its interior or exterior surface. The threaded section may be configured so that the elongated hollow cylindrical metal stub out is a female receptor that engages a male threaded plug; or it may be configured so that the elongated hollow cylindrical rigid stub out is a male threaded connector that engages a female threaded cap. The threaded plug or cap removably engages the threaded section of the stub out pipe and securely attached thereto.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The present invention is to be used as a one-piece re-sealable pre-assembled plumbing stub out during construction of rigid piping systems. In the present embodiment, each one-piece re-sealable pre-assembled plumbing stub out is comprised of an open ended copper pipe and an elongated hollow cylindrical brass fitting having an inner collar and an outer collar. It is to be understood that the present invention may be comprised of any metal or other rigid material sufficient for use in a plumbing pipe environment. The fact that the present embodiment is identified as utilizing brass and copper is not intended to limit the invention to requiring two pieces of metal that require soldering to generate a one-piece re-sealable pre-assembled plumbing stub out. The invention may be a one-piece apparatus comprised of one type of rigid material. In addition, regarding the aspect of soldering the open ended copper pipe and an elongated hollow cylindrical brass fitting, it is to be understood that it is contemplated that the soldering done is not to be limited to traditional types of soldering and should include the use of silver solder and other means of attaching open ended copper pipe and an elongated hollow cylindrical brass fitting.

In the embodiment illustrated in FIG. 1, the elongated hollow cylindrical brass fitting is one inch in length. The diameter of the elongated hollow cylindrical brass fitting may be one-half inch, three-fourths inch or one inch. It is to be understood that the diameter of the elongated hollow cylindrical brass fitting is dependent upon the size of copper pipe being used in the plumbing construction. The diameter of the elongated hollow cylindrical brass fitting is of a diameter relative to that of the copper pipe to allow a portion of it to slide into the copper pipe.

Referring to FIG. 1, an open ended copper stub out 1 is shown. The copper stub out is comprised of an elongated hollow cylindrical brass fitting 2 permanently attached to a copper pipe 30. In the present embodiment, the elongated hollow cylindrical brass fitting 2 is permanently attached to the copper pipe 30 by inserting the inner collar (not shown) of the elongated hollow cylindrical brass fitting 2 into the copper pipe 30 and soldering them together. It is to be understood that the present invention is not intended to be limited to permanent attachment of the elongated hollow cylindrical brass fitting 2 to the copper pipe 30 by way of soldering. The present invention is intended to cover any method of permanently attaching the elongated hollow cylindrical brass fitting 2 to the copper pipe 30. It is to be further understood that the present invention is intended to encompass any means of attaching the elongated hollow cylindrical brass fitting 2 to copper pipe 30 whereby the attached thereto is leak proof, even if the attachment is not permanent. It is to be also understood that the invention 1, including the elongated hollow cylindrical brass fitting 2 and the copper pipe 30 may be a single configuration.

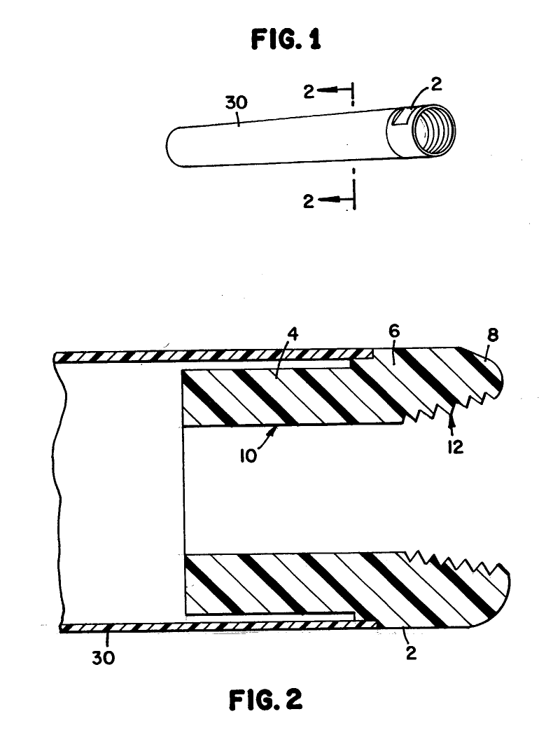

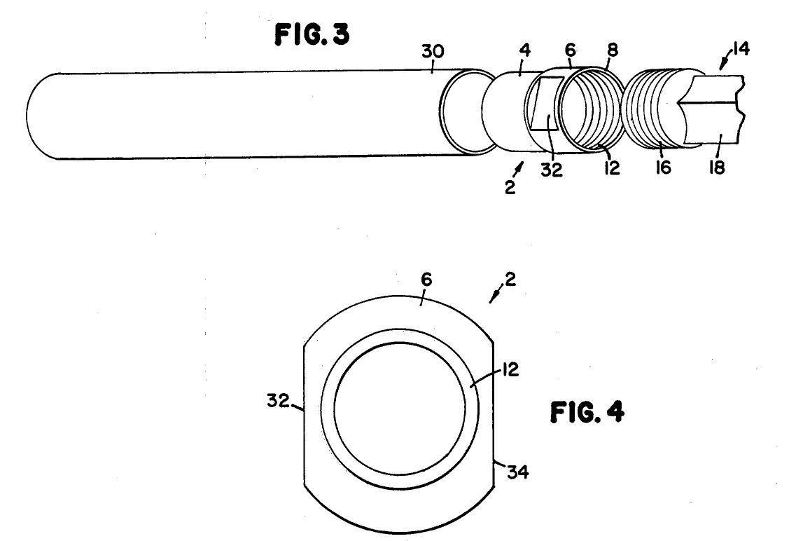

As illustrated in FIGS. 2 and 3, the elongated hollow cylindrical brass fitting 2 has an inner collar 4 and an outer collar 6. The inner collar 4 of the elongated hollow cylindrical brass fitting 2 is a male insert that slides into an open end of a copper pipe 30 and is welded in place. The outer collar 6 of the elongated hollow cylindrical brass fitting 2 has a rounded tip 8. The interior surface 10 of the inner collar 4 has a smooth surface. The interior surface 12 of the outer collar 6 is threaded. The threaded surface 12 of the outer collar 6 is configured as a female portion of the elongated hollow cylindrical brass fitting 2 so that it may receive a threaded plug 14. The threaded plug 14 has a threaded male portion 16 and a tool-gripping portion 18. The threaded plug 14 removably engages the threaded surface 12 of the outer collar 6 by screwing the threaded plug 14 into the elongated hollow cylindrical brass fitting 2 to create a leak proof plug. This occurs following the secure welding of the elongated hollow cylindrical brass fitting 2 to an open end of copper pipe 30. The threaded plug 14 is leak proof once fully screwed in the appropriate direction and may be removed by screwing the threaded plug 14 in the opposite direction. Since the threaded plug 14 is screwed in place into the elongated hollow cylindrical brass fitting 2 instead of being permanently soldered, it can be removed and replaced as needed. The insertion and removal of the threaded plug 14 allows for the draining of debris, pressure testing and inspection of the copper piping throughout a newly constructed building without the traditional cutting and re-capping of permanently closed bullet stub outs or stub outs that are soldered closed.

FIG. 3 includes an unassembled front view of a stub out that may be sealed and resealed. The stub out is comprised of a copper pipe 30, elongated hollow cylindrical brass fitting 2, and threaded plug 14. The frontal view of the elongated hollow cylindrical brass fitting 2 illustrates the inner collar 4, outer collar 6, threaded interior surface 12 of the outer collar 6 and a first planar portion 32. The elongated hollow cylindrical brass fitting 2 is soldered to the copper pipe 52 after being inserted the copper pipe 52, thereby forming an open end copper stub out 50. The re-sealable stub out illustrated in FIG. 3 may be transformed an open end stub out to a closed stub out by screwing the threaded plug 14 into the outer collar 6 of the elongated hollow cylindrical brass fitting 2.

FIG. 4 is a top view of the elongated hollow cylindrical brass fitting 2, illustrating the outer collar 6, the rounded tip 8 of the elongated hollow cylindrical brass fitting 2 and the opposed first and second planar portions 32, 34 of the outer collar 6.

In one embodiment, the elongated hollow cylindrical brass fitting 2 is one-half inch in diameter and one inch in length. The brass fitting is created by drilling a hole through a solid brass fitting, using a one-fourth inch iron pipe hole. The threaded inner surface of the outer collar is configured with one-fourth inch tapered threads. In alternative embodiments the threaded inner surface of the outer collar may be configured with seven-sixteenth, one-half, three-eighth or five-sixteenth inch-tapered threads. It is to be understood that it is contemplated that the dimensions of the threaded inner surface of the outer collar may be any dimensions so long as the threads allow for a leak proof seal.

In another embodiment, the elongated hollow cylindrical brass fitting 2 is three-fourths of an inch in diameter and one inch in length. The brass fitting is created by drilling a hole through a solid brass fitting, using a three-fourths of an inch iron pipe hole. The threaded inner surface of the outer collar is configured with three-fourths of an inch-tapered thread. In another embodiment, the elongated hollow cylindrical brass fitting 2 is one inch in diameter and one inch in length. The brass fitting is created by drilling a hole through a solid brass fitting, using a one-inch iron pipe hole. The threaded inner surface of the outer collar is configured with one inch tapered threads.

It is foreseen that the elongated hollow cylindrical brass fitting 2 could be adapted for use in other piping construction environments other than plumbing stub out applications and the invention is not to be considered limited to the environment shown. In addition the dimensions provided are simply for use in describing preferred embodiments adapted for use with conventional plumbing pipe stub outs of generally standardized dimensions. However, the dimensions provided above should not be deemed limiting and it is foreseen that the dimensions of the pipes could be changed to accommodate various applications. It is thus to be understood that while certain forms of the present invention have been illustrated and described herein, it is not to be limited to the specific forms or arrangement of parts described and shown.

What is claimed:

1. A stub out adapter that is connect to an open ended piping assembly stub out to allow the stub out to be removably sealed, the adapter comprising:
a. an elongated hollow cylindrical fitting including first and second ends, wherein said first end is attached to the stub out and said second end has a threaded surface that allows a removable seal to threadingly engage said elongated hollow cylindrical fitting, to create a leak proof seal.

2. The stub out adapter of claim 1 wherein said elongated hollow cylindrical fitting is comprised of metal.

3. The stub out adapter of claim 2 wherein said elongated hollow cylindrical metal fitting is comprised of brass.

4. The stub out adapter of claim 1 wherein said removable seal is comprised of a threaded male plug.

5. The stub out adapter of claim 1 wherein said removable seal is comprised of a threaded female cap.

6. The stub out adapter of claim 1 wherein said first end of said elongated hollow cylindrical fitting is dimensioned such that said first end is a male insert to an open end of the stub out.

7. The stub out adapter of claim 1 wherein said first end of said elongated hollow cylindrical fitting is dimensioned such that said first end is a female receptor configured to receive an open end of the stub out.

8. The stub out adapter of claim 1 wherein said second end of said elongated hollow cylindrical fitting has threads on the inner surface of the second end of said elongated hollow cylindrical fitting for engaging a male threaded plug.

9. The stub out adapter of claim 1 wherein said second end of said elongated hollow cylindrical fitting has threads on the outer surface of the second end of said elongated hollow cylindrical fitting for engaging a female threaded cap.

10. The stub out adapter of claim 1 wherein the first end of said elongated hollow cylindrical fitting is dimensioned such that it is a male insert to an open end of the stub out.

11. An elongated hollow cylindrical stub out having first and second ends wherein said first end has threads on a portion of its interior surface that allow said stub out to be plugged with a threaded plug that engages said first end of said stub out by screwing the plug into said first end.

12. The stub out of claim 11 wherein the first end of the stub out is comprised of an elongated hollow cylindrical fitting having first and second ends, and the second end of the stub out is a section of pipe, said elongated hollow cylindrical fitting is securely attached to said section of pipe as a male insert.

13. A stub out having first and second ends wherein said first end has threads on a portion of its exterior surface that allow said stub out to be capped with a threaded cap that engages said first end of said stub out by screwing the cap onto said first end.
